(19) United States
(12) Patent Application Publication
(10) Pub. No.: US 2026/0298214 A1
(43) Pub. Date: Oct. 1, 2026

(54) SHAFT-TYPE POWER GENERATION DEVICE BASED ON VERTICAL TEMPERATURE DIFFERENCE OF MOUNTAIN BODY AND SOLAR HEAT COLLECTION

(71) Applicant: Zhao SONG, Jinan (CN)

(72) Inventor: Zhao SONG, Jinan (CN)

(21) Appl. No.: 19/435,965

(22) Filed: Dec. 30, 2025

(30) Foreign Application Priority Data
Apr. 1, 2025 (CN) 2025103981303

(51) Int. Cl. F03G 6/04; F03D 9/00; F03D 9/48

(52) U.S. Cl. CPC F03G 6/045; F03D 9/007; F03D 9/48; F05B 2220/20; F05B 2220/706; F05B 2270/3011; F05B 2270/303; F05B 2270/32

(57) ABSTRACT

A shaft-type power generation device based on vertical temperature difference of mountain body and solar heat collection, including a shaft way formed in mountain body including wind inlet in bottom and wind outlet in top, a heat storage device is laid on ground surface at wind inlet, a heat absorption device is erected on ground surface at wind inlet, a support formwork is fixedly mounted on inner wall of shaft way, three generators are respectively fixedly mounted in shaft way via three mounting frames on support formwork, and maintenance chambers corresponding to three generators respectively are disposed in mountain body; and each generator has a central shaft, twenty-five blades and rotating shafts, a current receiving assembly, and an induction frame, ends of twenty-five rotating shafts are jointly rotatably connected to power generation coil being rotatably connected to inner wall of induction frame.

### CROSS-REFERENCE TO RELATED APPLICATIONS

The present invention claims priority benefits to Chinese Patent Application No. 202510398130.3, entitled “SHAFT-TYPE POWER GENERATION DEVICE BASED ON VERTICAL TEMPERATURE DIFFERENCE OF MOUNTAIN BODY AND SOLAR HEAT COLLECTION”, filed on Apr. 1, 2025, with the China National Intellectual Property Administration, and the entire contents of which are incorporated herein by reference and constitute a part of the present invention for all purposes.

### TECHNICAL FIELD

The present invention relates to the technical field of thermoelectric power generation, and particularly, to a shaft-type power generation device based on a vertical temperature difference of a mountain body and solar heat collection.

### BACKGROUND

The shaft-type power generation device based on solar air collection and high mountains is a new energy solution that utilizes natural geographical features and renewable energy technology to efficiently and sustainably generate electricity by utilizing the vertical temperature difference effect of mountain bodies and solar energy resources.

There is already a device that excavates a shaft cavity in the mountain body with a vertical temperature difference, forms a side opening southward at the foot of the mountain, and is equipped with an efficient solar air collector, such that the temperature of the air entering the shaft cavity is significantly increased, thereby enhancing the temperature difference between the foot and top of the mountain, and promoting the upward flow rate of hot air. As a result, the hot air with high temperature at the foot of the mountain naturally rises and rapidly flows to the region with low temperature at the top of the mountain. This hot air is guided into a gas turbine engine mounted in the shaft cavity for power generation, thereby achieving the engineering goal of efficient power generation.

However, when the temperature difference between the top and foot of the mountain is less than a certain range, the airflow in the shaft cavity will be relatively slow. The flow velocity will be further reduced as the airflow passes through the wind turbine generator, making it difficult for the airflow to rapidly circulate, i.e., making it difficult for the airflow to exit from the top of the mountain. This phenomenon occurs when the temperature difference between the top and foot of the mountain is not zero. Therefore, existing devices that utilize vertical temperature differences for power generation still have deficiencies in practical use, and measures to ensure rapid airflow circulation in the shaft cavity require further improvement.

### SUMMARY

An objective of the present invention is to provide a shaft-type power generation device based on a vertical temperature difference of a mountain body and solar heat collection, which can perform automatic regulation based on external environmental conditions to ensure rapid airflow circulation, thereby solving the problems mentioned in the background above.

To achieve the above objective, the present invention provides the following technical solution.

A shaft-type power generation device based on a vertical temperature difference of a mountain body and solar heat collection, including: a shaft way formed in the mountain body, a wind inlet is formed at a bottom of the shaft way, a wind outlet is formed at a top of the shaft way, a heat storage device is laid on a ground surface at the wind inlet, a heat absorption device is erected on the ground surface at the wind inlet, a support formwork is fixedly mounted on an inner wall of the shaft way, three generators are respectively fixedly mounted in the shaft way via three mounting frames on the support formwork, and maintenance chambers corresponding to the three generators respectively are disposed in the mountain body;
each of the generators includes a central shaft, twenty-five blades, twenty-five rotating shafts, a current receiving assembly, and an induction frame, where ends of the twenty-five rotating shafts are jointly rotatably connected to a power generation coil, the power generation coil is rotatably connected to an inner wall of the induction frame, the central shaft is rotatably connected to an inner wall of each of the generators, and a regulating component for synchronously controlling deflection states of the twenty-five blades, and a locking component are disposed in the central shaft; and
the shaft-type power generation device, further including an environmental monitoring component, a wind direction detection module, a generator regulation module, and an early warning module, where the wind direction detection module is configured to detect an wind inlet angle θ and regulate a temperature difference trigger threshold WC accordingly, the generator regulation module is configured to evaluate operating states of the three generators based on environmental data, the early warning module is configured to analyze a wind pressure fluctuation in the shaft way, and the regulating components are configured to automatically regulate the blades based on the operating states of the generators and the wind pressure fluctuation in the shaft way.

Optionally, the environmental monitoring component includes:
a first temperature sensor and a second temperature sensor disposed at the wind inlet and the wind outlet of the shaft way respectively, where a vane is disposed on the ground surface at the wind inlet, a flow velocity sensor and a viscometer are disposed at the wind inlet of the shaft way, and a wind pressure sensor is disposed at the wind inlet of the shaft way.

Optionally, the regulating component includes: a gear ring, where shaft walls of the twenty-five rotating shafts are all rotatably connected to an inner wall of the central shaft, fixedly connected to inner walls of the twenty-five blades respectively and all fixedly connected to gears, teeth of the twenty-five gears are all engaged with teeth of the gear ring, the inner wall of each of the generators is fixedly connected to a regulating motor, and an output end of the regulating motor is fixedly connected to a surface of the gear ring; and the locking component.

Optionally, a detection process for the wind direction detection module is as follows:

$$WD = \{ \begin{matrix}1 , if 70 ° \leq 110 ° \\ 2 , if 45 ° < θ < 70 ° or 110 ° < θ < 135 ° \\ 3 , if 0 ° \leq θ \leq 45 ° or 135 ° \leq θ \leq 180 °\end{matrix} ;$$

wherein, WD denotes a wind direction influence level; θ denotes the wind inlet angle, i.e., the wind inlet angle of the shaft way;

$$WC = α \times ( {W}_{1} - {W}_{2} ) ;$$

wherein, WC denotes the temperature difference trigger threshold; W₁ is a temperature at the wind inlet at the foot of a mountain; W₂ is a temperature at the wind outlet at the top of the mountain;
when WD=1, a high level is indicated, representing that an external wind direction is in a state of superimposing and accelerating an airflow in the shaft way, in which case α is taken as

$$\frac{1}{2} ;$$

when WD=2, a medium level is indicated, representing that the external wind direction is in a state of merely accelerating the airflow in the shaft way, in which case α is taken as

$$\frac{3}{5} ;$$

when WD=3, a low level is indicated, representing that the external wind direction is in a state of non-accelerating the airflow in the shaft way, in which case α is taken as 1; and
a wind direction of a current environment is detected, the wind direction influence level is set, the temperature difference trigger threshold WC is regulated based on the wind direction influence level, and the regulating component is not started when an actual temperature difference≥the temperature difference trigger threshold WC and is started when the actual temperature difference<the temperature difference trigger threshold WC.

Optionally, the environmental data includes a flow velocity v of a fluid and a fluid Reynolds number Rₑ, and during regulation by the generator regulation module, the flow velocity v of the fluid is obtained as follows:

$$v = \frac{{P}_{air}}{{ρ}_{air}} ;$$

wherein, v is the flow velocity of the fluid; Pₐᵢᵣ is an air pressure; ρₐᵢᵣ is an air density;
a wind velocity threshold for the flow velocity v of the fluid is set as V₁; when the flow velocity v of the fluid>the wind velocity threshold V₁, a high wind velocity state is indicated;
when the flow velocity v of the fluid≤the wind velocity threshold V₁, a low wind velocity state is indicated;
the fluid Reynolds number Rₑ is obtained as follows:

$${R}_{e} = \frac{ρ vd}{μ} ;$$

wherein, Rₑ is the fluid Reynolds number; v is the flow velocity of the fluid; ρ is a fluid density; μ is a viscosity coefficient; d is a shaft way length;
a Reynolds threshold for the fluid Reynolds number Rₑ is set as R₁;
when Rₑ>R₁, a high Reynolds number is indicated, representing that the airflow is in a turbulent state;
when Rₑ≤R₁, a low Reynolds number is indicated, representing that the airflow is in a laminar state;

$$A = \{ \begin{matrix}a , V > {V}_{1} ⋂ {R}_{e} > {R}_{1} \\ b , V < {V}_{1} ⋂ ( {R}_{e} > {R}_{1} ⋃ {R}_{e} \leq {R}_{1} ) ; \\ c , V > {V}_{1} ⋂ {R}_{e} < {R}_{1}\end{matrix}$$

wherein, A=a, A=b, and A=c respectively denotes three fluid states in the shaft way;
when A=a, a first level is indicated, representing that the fluid is in a high-velocity turbulent flow state;
when A=b, a second level is indicated, representing that the fluid is in a low-velocity state;
when A=c, a third level is indicated, representing that the fluid is in a high-velocity laminar flow state; and
the generator located at a middle position of the shaft way is shut down at the first level, the two generators located at the middle position and a position close to the wind outlet are shut down at the second level, and none of the three generators are shut down at the third level.

Optionally, an early warning process for the early warning module is as follows:

$$p ( t ) = \frac{1}{2} \times ρ ( t ) \times {v ( t )}^{2} ;$$

wherein, p(t) is a wind pressure at a time point t; ρ(t) is an air density at the time point t, which varies with the temperature and the air pressure; v(t) is a wind velocity at the time point t;

$$Δ p = \vert p ( t ) - p ( t - 1 ) \vert ;$$

wherein, p(t) is the wind pressure at the time point t; p(t−1) is a wind pressure at a time point t−1; Δp is a wind pressure difference between the time point t and the time point t−1; and
a wind pressure threshold for the wind pressure difference Δp between the time point t and the time point t−1 is set as Δp_{threshold}, and if the wind pressure threshold Δp_{threshold}<the wind pressure difference Δp between the time point t and the time point t−1, excessive wind pressure fluctuation is determined, the twenty-five blades on each of the generators possibly encounter an uneven wind pressure affecting safe operation, and all the three regulating components operate to cause the blades of the three generators to be all in a non-operating state.

Optionally, the locking component includes an electromagnet embedded in the inner wall of the induction frame, and an inner wall of the power generation coil is embedded with an iron ring.

Optionally, the blades are made of a waterproof and corrosion-resistant material, the heat storage device stores heat using cobblestones, and the heat absorption device absorbs heat by erecting a plastic film.

Compared with the prior art, the present invention has the following beneficial effects:
firstly, through the cooperation of the structures such as the shaft way, the heat absorption device, and the heat storage device, the present invention utilizes the temperature difference generated between the wind outlet and the wind inlet of the shaft way to drive the generators to operate for power generation, thereby enabling the device to operate for power generation throughout the year with low energy consumption and high economic return;
secondly, considering that the airflow in the shaft way will be relatively slow when the temperature difference between the top and foot of the mountain is less than a certain range, and to avoid the situation where the airflow cannot exit from the wind outlet smoothly, the present invention, through the cooperation of the structures such as the gears, the rotating shafts, and the gear rings, collects data on the surrounding environment of the device by the environmental monitoring component, and separately controls the deflection states of the blades on the three generators, thereby reducing airflow resistance and avoiding poor airflow circulation in the shaft way;
thirdly, the present invention analyzes the collected data in real time by the wind direction detection module to determine the value of the temperature difference trigger threshold that triggers the regulating component to operate, such that the device can more precisely regulate airflow resistance reduction, resulting in more targeted regulation;
fourthly, the present invention comprehensively determines the flow velocity and the Reynolds number of the airflow in the shaft way, defines three flow states of the fluid, namely the high-velocity turbulent flow state, the low-velocity flow state, and the high-velocity laminar flow state, and proposes the corresponding operating states of the three regulating components based on the three states, thereby enabling the regulatory measures for avoiding poor airflow circulation in the shaft way to be more targeted and precise.

### BRIEF DESCRIPTION OF THE DRAWINGS

FIG. 1 is a first planar cross-sectional view of the present invention;

FIG. 2 is a second planar cross-sectional view of the present invention;

FIG. 3 is an enlarged view of a structure at A in FIG. 2 of the present invention;

FIG. 4 is a third planar cross-sectional view of the present invention;

FIG. 5 is an enlarged view of a structure at B in FIG. 4 of the present invention;

FIG. 6 is an enlarged view of a structure at C in FIG. 5 of the present invention;

FIG. 7 is a cross-sectional view of a connecting part between a power generation coil and an induction frame according to the present invention;

FIG. 8 is a top view of a generator according to the present invention;

FIG. 9 is a schematic diagram of transmission from a regulating motor to a rotating shaft in a top view according to the present invention;

FIG. 10 is an axonometric view of a blade and a rotating shaft according to the present invention;

FIG. 11 is a schematic diagram of modules according to the present invention;

FIG. 12 is a flowchart of a wind direction detection module according to the present invention;

FIG. 13 is a flowchart of a generator adjustment module according to the present invention; and

FIG. 14 is a flowchart of an early warning module according to the present invention.

In the drawings: 1, ground surface; 2, mountain body; 3, shaft way; 4, heat absorption device; 5, support formwork; 6, mounting frame; 7, generator; 8, maintenance chamber; 9, regulating motor; 10, gear ring; 11, gear; 12, heat storage device; 21, electromagnet; 22, iron ring;
701, central shaft; 702, blade; 703, rotating shaft; 704, power generation coil; 705, induction frame; and, 706, current receiving assembly.

### DETAILED DESCRIPTION

The technical solutions in examples of the present invention will be described clearly and completely below in conjunction with the accompanying drawings in the examples of the present invention. Obviously, the described examples are only a part of examples of the present invention, not all of them. All other examples obtained by those of ordinary skill in the art based on the examples in the present invention without creative efforts shall fall within the scope of protection of the present invention.

### Example 1

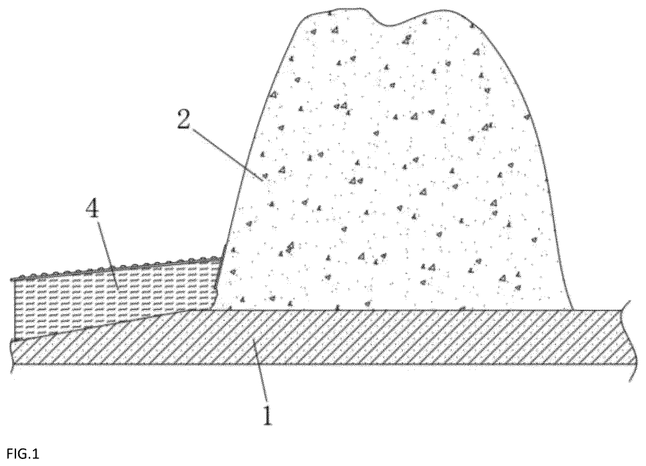

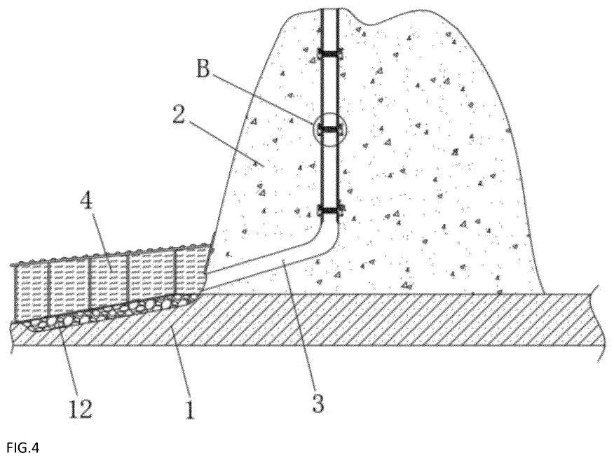

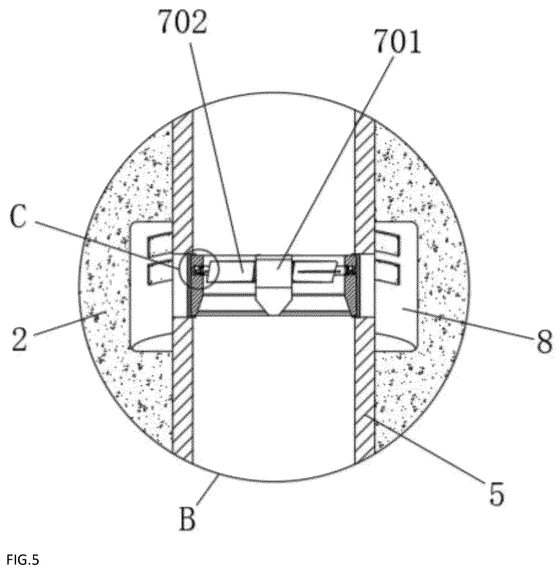

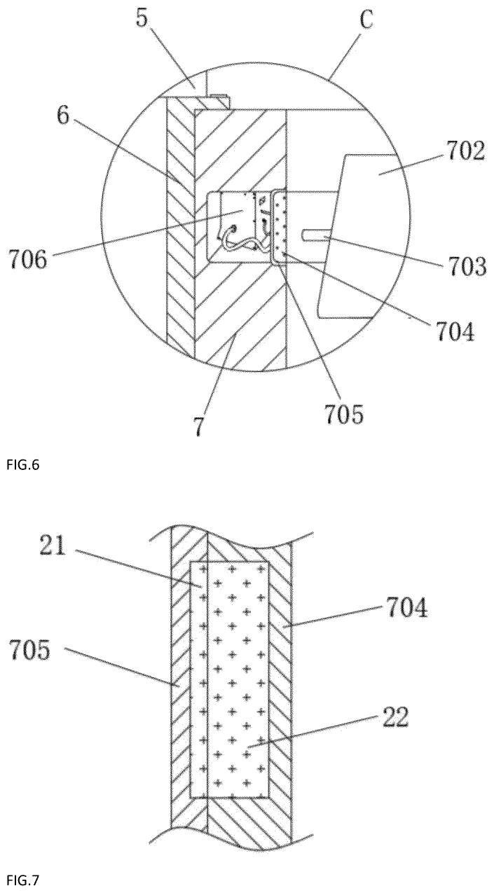

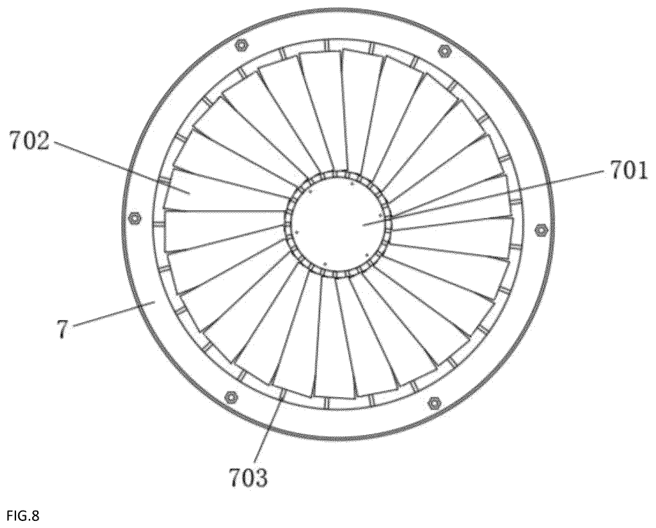

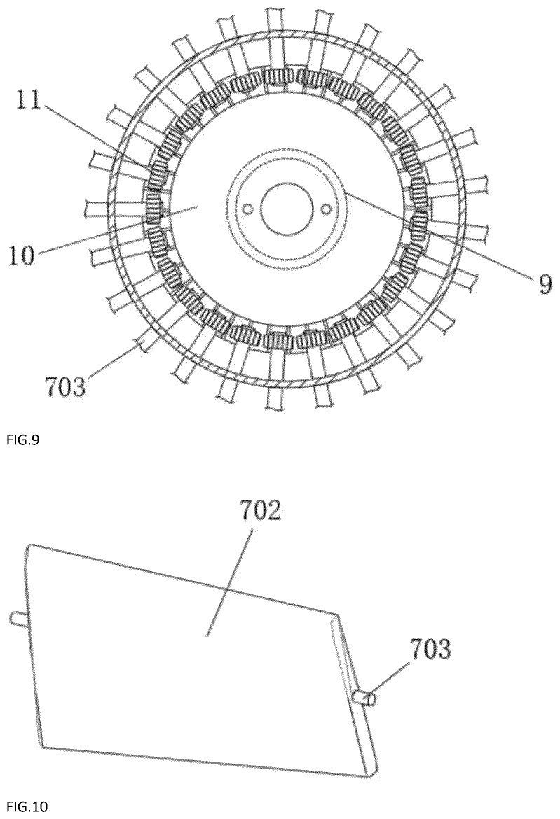

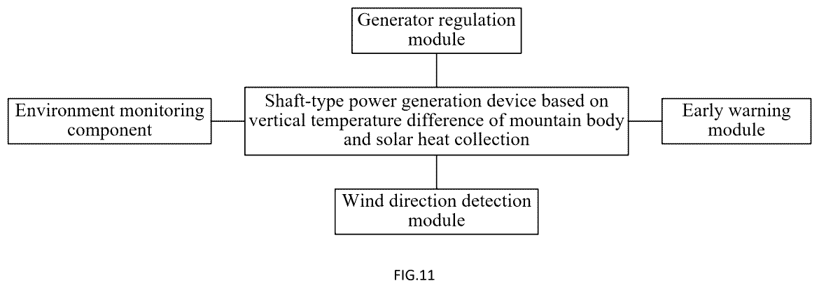

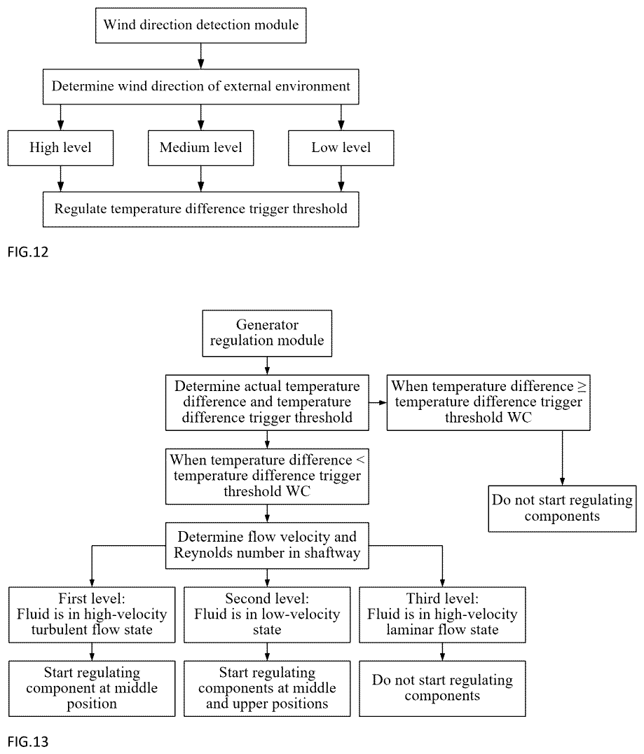

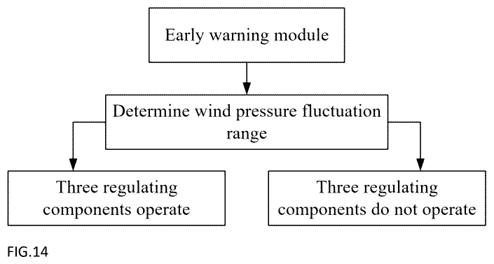

Referring to FIG. 1 to FIG. 14, the present invention provides a shaft-type power generation device based on a vertical temperature difference of a mountain body and solar heat collection, including a shaft way 3 formed in the mountain body 2, wherein a wind inlet is formed in a bottom of the shaft way 3, a wind outlet is formed in a top of the shaft way 3, a heat storage device 12 is laid on a ground surface 1 at the wind inlet, a heat absorption device 4 is erected on the ground surface 1 at the wind inlet, a support formwork 5 is fixedly mounted on an inner wall of the shaft way 3, three generators 7 are respectively fixedly mounted in the shaft way 3 via three mounting frames 6 on the support formwork 5, and maintenance chambers 8 corresponding to the three generators 7 respectively are disposed in the mountain body 2.

Each of the generators 7 includes a central shaft 701, twenty-five blades 702, twenty-five rotating shafts 703, a current receiving assembly 706, and an induction frame 705, where ends of the twenty-five rotating shafts 703 are jointly rotatably connected to a power generation coil 704, the power generation coil 704 is rotatably connected to an inner wall of the induction frame 705, the central shaft 701 is rotatably connected to an inner wall of each of the generators 7, and a regulating component for synchronously controlling deflection states of the twenty-five blades 702, and a locking component are disposed in the central shaft 701.

The shaft-type power generation device further includes an environmental monitoring component, a wind direction detection module, a generator regulation module, and an early warning module, where the wind direction detection module is configured to detect an wind inlet angle θ and regulate a temperature difference trigger threshold WC accordingly, the generator regulation module is configured to evaluate operating states of the three generators 7 based on environmental data, the early warning module is configured to analyze a wind pressure fluctuation in the shaft way 3, and the regulating components are configured to automatically regulate the blades 702 based on the operating states of the generators 7 and the wind pressure fluctuation in the shaft way 3.

The environmental monitoring component includes a first temperature sensor and a second temperature sensor disposed at the wind inlet and the wind outlet of the shaft way 3 respectively, where a vane is disposed on the ground surface 1 at the wind inlet, a flow velocity sensor and a viscometer are disposed at the wind inlet of the shaft way 3, and a wind pressure sensor is disposed at the wind inlet of the shaft way 3.

The regulating component includes: a gear ring 10, where shaft walls of the twenty-five rotating shafts 703 are all rotatably connected to an inner wall of the central shaft 701, the shaft walls of the twenty-five rotating shafts 703 are fixedly connected to inner walls of the twenty-five blades 702 respectively, the shaft walls of the twenty-five rotating shafts 703 are all fixedly connected to gears 11, teeth of the twenty-five gears 11 are all engaged with teeth of the gear ring 10, the inner wall of each of the generators 7 is fixedly connected to a regulating motor 9, and an output end of the regulating motor 9 is fixedly connected to a surface of the gear ring (10); and the locking component.

The locking component includes an electromagnet 21, wherein, the electromagnet 21 is embedded in the inner wall of the induction frame 705, and an inner wall of the power generation coil 704 is embedded with an iron ring 22.

The blades 702 are made of a waterproof and corrosion-resistant material, the heat storage device 12 stores heat using cobblestones, and the heat absorption device 4 absorbs heat by erecting a plastic film.

More specifically, in this example: by disposing the shaft way 3 and orienting the wind outlet towards the south, a temperature difference will be generated between the wind outlet and the wind inlet of the shaft way 3 in a daily usage environment. The temperature difference causes an airflow to move from a high-temperature position to a low-temperature position in the shaft way 3. In addition, by laying a large area of cobblestones, the heat storage device 12 accumulates a large amount of heat at the wind inlet, such that a greater temperature difference is generated between the foot and top of a mountain, thereby driving the airflow in the shaft way 3 to move rapidly upwards. The rapid upward airflow in the shaft way 3 drives the blades 702 on the generator 7 to rotate, such that the power generation coil 704 rapidly rotates along the inner wall of the induction frame 705 through the transmission of the rotating shafts 703, thereby continuously cutting magnetic induction lines based on the power generation principle of electromagnetic induction for power generation. A generated current is stored by the current receiving assembly 706. The process of generating the current for power generation and storage is the prior art, and thus the specific principle thereof will not be repeated herein.

During use, considering that the airflow in the shaft way 3 will be relatively slow when the temperature difference between the top and foot of the mountain is less than a certain range, the airflow sequentially passes through the three generators 7 to further reduce the flow velocity. Therefore, when the temperature difference between the top and foot of the mountain is small, the airflow cannot exit from the wind outlet smoothly. In this case, the environmental monitoring component can be used to collect data on the surrounding environment of the device, and the wind direction detection module and the generator regulation module can be used to analyze the collected data in real time, such that the deflection states of the blades 702 on the three generators 7 can be controlled as needed based on the analyzed data, thereby reducing airflow resistance and avoiding poor airflow circulation in the shaft way 3.

When it is necessary to control the deflection of the blades 702, the current stored by power generation of the generator 7 can be utilized to drive the regulating motor 9 with a small amplitude, thereby causing the gear ring 10 to rotate slightly. Through the slight rotation of the gear ring 10, the gears 11 rotate. Taking the transmission of a single gear 11 as an example, the rotation of the gear 11 causes the connected rotating shaft 703 to rotate, which in turn causes the blade 702 to self-deflect, such that the blade 702 is regulated to a state where it does not obstruct an airflow path. In this way, all the twenty-five blades 702 on the generator 7 can be regulated in a self-deflecting manner by slightly rotating the gear ring 10. Meanwhile, in this process, the current stored by power generation of the generator 7 can also energize the electromagnet 21, such that the electromagnet 21 becomes magnetic and attracts the iron ring 22, thereby keeping the power generation coil 704 and the induction frame 705 relatively stationary. That is, through this measure, the blades 702 do not perform revolution-type power generation.

The shaft way 3 can be formed by using existing conditions such as abandoned mine tunnels, vertical shafts formed by geological exploration, and decommissioned emergency projects, which only requires the erection of supporting structures on the inner wall, thereby significantly reducing construction costs.

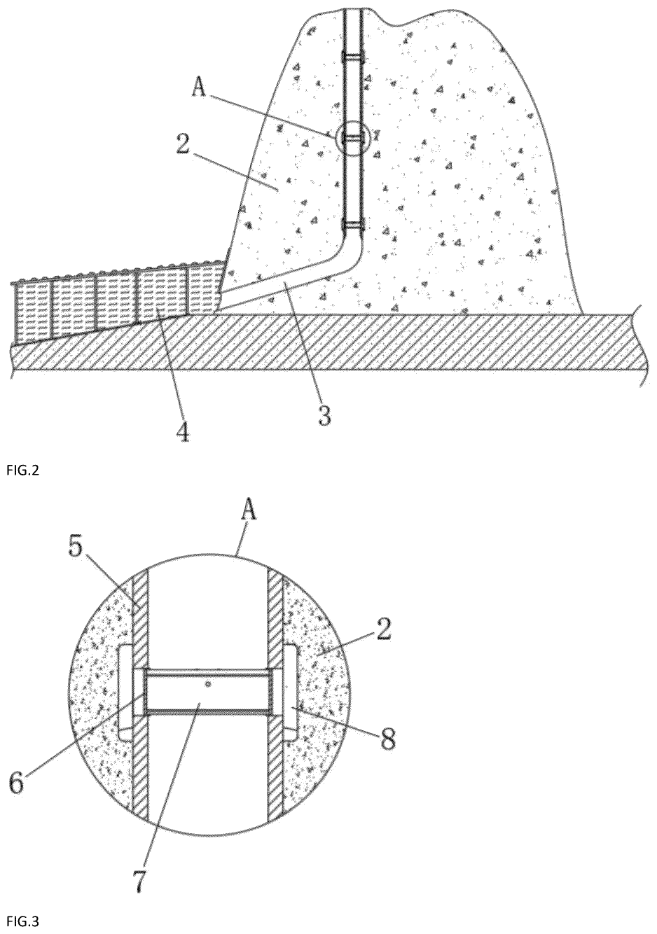

Example 2, based on the above example:
referring to FIG. 2, in the present example: a depth of the shaft 3 can be set to 800 m, and multiple generators 7 are erected at equal intervals of 100 m. Based on this, a vertical space of the shaft way 3 is divided into three sections. When there is a need to control one generator 7 in the above process, it is regarded as synchronous regulation of all generator sets contained in a region covered by the shaft way 3 in this example. The arrangement of multiple generators 7 can significantly improve the energy conversion efficiency of the device.

Example 3, based on the above examples:
referring to FIG. 1 and FIGS. 11 to 14, the environmental monitoring component includes a first temperature sensor and a second temperature sensor disposed at the wind inlet and the wind outlet of the shaft way 3 respectively, where a vane is disposed on the ground surface 1 at the wind inlet, a flow velocity sensor and a viscometer are disposed at the wind inlet of the shaft way 3, and a wind pressure sensor is disposed at the wind inlet of the shaft way 3.

A detection process for the wind direction detection module is as follows:
a radial coincident direction of the wind inlet of the shaft way 3 is defined as a 90° direction;

$$WD = \{ \begin{matrix}1 , if 70 ° \leq θ \leq 110 ° \\ 2 , if 45 ° < θ < 70 ° or 110 ° < θ < 135 ° \\ 3 , if 0 ° \leq θ \leq 45 ° or 135 ° \leq θ \leq 180 °\end{matrix} ;$$

wherein, WD denotes a wind direction influence level; 0 denotes the wind inlet angle, i.e., the wind inlet angle of the shaft way 3;

$$WC = α \times ( {W}_{1} - {W}_{2} ) ;$$

wherein, WC denotes the temperature difference trigger threshold; W₁ is a temperature at the wind inlet at the foot of a mountain; W₂ is a temperature at the wind outlet at the top of the mountain;
when WD=1, a high level is indicated, representing that an external wind direction is in a state of superimposing and accelerating an airflow in the shaft way 3, in which case α is taken as

$$\frac{1}{2} ;$$

when WD=2, a medium level is indicated, representing that the external wind direction is in a state of merely accelerating the airflow in the shaft way 3, in which case α is taken as

$$\frac{3}{5} ;$$

when WD=3, a low level is indicated, representing that the external wind direction is in a state of non-accelerating the airflow in the shaft way 3, in which case α is taken as 1; and
a wind direction of a current environment is detected, the wind direction influence level is set, the temperature difference trigger threshold WC is regulated based on the wind direction influence level, and the regulating component is not started when an actual temperature difference≥the temperature difference trigger threshold WC and is started when the actual temperature difference<the temperature difference trigger threshold WC.

More specifically, in this example: the vane is disposed on the ground surface 1 at the wind inlet to detect a wind direction of a current natural environment. The direction of the wind inlet angle θ is determined to determine which of the three states, namely the superimposing and accelerating state, the accelerating state, and the non-accelerating state, the airflow generated in the shaft way 3 due to the temperature difference is in. The temperature difference trigger threshold WC is then regulated based on the current level. That is, the regulating component is not started when the actual temperature difference≥the temperature difference trigger threshold WC and is started when the actual temperature difference<the temperature difference trigger threshold WC. More specifically, the temperature difference trigger threshold WC that triggers the regulating component to operate is relatively low when the natural wind entered superimposes and accelerates the airflow in the shaft way 3 and is relatively high when the natural wind entered does not accelerate the airflow in the shaft way 3.

In this way, it is first considered that when the temperature difference between the top and foot of the mountain is small, the airflow cannot exit from the wind outlet smoothly. That is, when the actual temperature difference is less than the temperature difference trigger threshold WC, the blades 702 of the generator 7 can be controlled as needed to reduce airflow resistance and avoid poor circulation. In addition, the wind direction factor in the natural environment is also utilized to regulate the temperature difference trigger threshold WC, making the device more practical and the timing of actual regulation more precise.

Example 4, based on the above examples:
referring to FIG. 2 to FIG. 13, the environmental data includes a flow velocity v of a fluid and a fluid Reynolds number Rₑ, and during regulation by the generator regulation module, the flow velocity v of the fluid is obtained as follows:

$$v = \frac{{P}_{air}}{{ρ}_{air}} ;$$

wherein, v is the flow velocity of the fluid; Pₐᵢᵣ is an air pressure; ρₐᵢᵣ is an air density;
a wind velocity threshold for the flow velocity v of the fluid is set as V₁; when the flow velocity v of the fluid>the wind velocity threshold V₁, a high wind velocity state is indicated;
when the flow velocity v of the fluid≤the wind velocity threshold V₁, a low wind velocity state is indicated;
the fluid Reynolds number Rₑ is obtained as follows:

$${R}_{e} = \frac{ρ vd}{μ} ;$$

wherein, Rₑ is the fluid Reynolds number; v is the flow velocity of the fluid; ρ is a fluid density; μ is a viscosity coefficient; d is a shaft way length;
a Reynolds threshold for the fluid Reynolds number Rₑ is set as R₁;
when Rₑ>R₁, a high Reynolds number is indicated, representing that the airflow is in a turbulent state;
when Rₑ≤R₁, a low Reynolds number is indicated, representing that the airflow is in a laminar state;

$$A = \{ \begin{matrix}a , & V > {V}_{1} ⋂ {R}_{e} > {R}_{1} \\ b , & V < {V}_{1} ⋂ ( {R}_{e} > {R}_{1} ⋃ {R}_{e} \leq {R}_{1} ) \\ c , & V > {V}_{1} ⋂ {R}_{e} < {R}_{1}\end{matrix} ;$$

wherein, A=a, A=b, and A=c respectively denote three fluid states in the shaft way 3;
when A=a, a first level is indicated, representing that the fluid is in a high-velocity and high-Reynolds-number state;
when A=b, a second level is indicated, representing that the fluid is in a low-velocity state;
when A=c, a third level is indicated, representing that the fluid is in a high-velocity and low-Reynolds-number state; and
the generator 7 located at a middle position of the shaft way is shut down at the first level, the two generators 7 located at the middle position and a position close to the wind outlet are shut down at the second level, and none of the three generators 7 are shut down at the third level.

More specifically, in this example: the flow velocity sensor, the viscometer, and the wind pressure sensor disposed in the shaft way 3 are used to detect the corresponding data. The wind velocity threshold V₁ is set for the flow velocity v of the fluid. When the flow velocity v of the fluid>the wind velocity threshold V₁, a high wind velocity state is indicated. When the flow velocity v of the fluid≤the wind velocity threshold V₁, a low wind velocity state is indicated. In this way, it is determined that the airflow in the shaft way 3 is in a high-velocity or low-velocity state, and the current fluid Reynolds number Rₑ is determined. On this basis, the Reynolds threshold R₁ is set for the fluid Reynolds number Rₑ, and it is determined whether the current airflow is in a turbulent flow or laminar flow state. When the fluid is in the high-velocity turbulent flow state, the blades 702 of the generator 7 located at the middle position are controlled to deflect, such that they are in a non-obstructing state. When the fluid is in the high-velocity laminar flow state, all the three generators 7 are in normal operation. When the fluid is in the low-velocity state, the blades 702 of the two generators 7 located at the middle position and the position close to the wind outlet are controlled to deflect, such that they are in a non-obstructing state.

In summary, when the temperature difference between the top and foot of the mountain is large, all the three generators 7 are in normal operation for power generation. When the temperature difference between the top and foot of the mountain is small, the wind velocity and the Reynolds number of the fluid in the shaft way 3 are determined to control the blades 702 of the three generators 7 as needed. When the fluid is the high-velocity turbulent flow state, the blades 702 of the generator 7 located at the middle position are controlled to deflect, such that they are in the non-obstructing state. In this case, the upper and lower generators 7 are used for power generation. Due to the high wind velocity, the airflow in the shaft way 3 can circulate. In addition, the blades 702 of the middle generator 7 do not obstruct the airflow, thereby increasing a distance between the adjacent operating generators 7 and avoiding the further intensification of turbulence in the adjacent operating generators 7 due to the high Reynolds number, while not affecting the continuity of the overall power generation operation of the device.

When the fluid is in the low-velocity state, the blades 702 of the two generators 7 located at the middle position and the position close to the wind outlet are controlled to deflect, such that they are in the non-obstructing state. In this case, the generator 7 that first comes into contact with the airflow is used for power generation. This approach, while maintaining overall sustainable power generation, reduces the resistance of the airflow passing through the shaft way 3 by reducing the overall power generation capacity of the device per unit time, thereby avoiding the difficulty of airflow circulation in the shaft way 3. When the fluid is in the high-velocity and low-Reynolds-number state, due to the high wind velocity, the effect of the Reynolds number needs not be considered, that is, all the three generators 7 operate normally.

Example 5, based on the above examples:
referring to FIGS. 2 to 14, an early warning process for the early warning module is as follows:

$$p ( t ) = \frac{1}{2} \times ρ ( t ) \times {v ( t )}^{2} ;$$

wherein, p(t) is a wind pressure at a time point t; ρ(t) is an air density at the time point t, which varies with the temperature and the air pressure; v(t) is a wind velocity at the time point t;

$$Δ p = \vert p ( t ) - p ( t - 1 ) \vert ;$$

wherein, p(t) is the wind pressure at the time point t; p(t−1) is a wind pressure at a time point t−1; Δp is a wind pressure difference between the time point t and the time point t−1; and
a wind pressure threshold for the wind pressure difference Δp between the time point t and the time point t−1 is set as Δp_{threshold}, and if the wind pressure threshold Δp_{threshold}<the wind pressure difference Δp between the time point t and the time point t−1, excessive wind pressure fluctuation is determined, the twenty-five blades 702 on each of the generators 7 possibly encounter an uneven wind pressure affecting safe operation, and all the three regulating components operate to cause the blades 702 of the three generators 7 to be all in a non-operating state.

More specifically, in this example: considering that the excessive wind pressure fluctuation will affect the operational stability and efficiency of the blades 702, in order to enhance the longevity of the device, the wind pressure value in the shaft way 3 is recorded a time point. The wind pressure threshold for the wind pressure difference Δp between the time point t and the time point t−1 is set as Δp_{threshold}. If the wind pressure threshold Δp_{threshold}<the wind pressure difference Δp between the time point t and the time point t−1, it is determined that the shaft way 3 is in a state of excessive wind pressure fluctuation. In this state, the twenty-five blades 702 on the generator 7 may encounter an uneven wind pressure, and all the three regulating components operate to cause the blades 702 of the three generators 7 to be all in a non-operating state, thereby avoiding abnormal operating environments and preventing impact on the long-term operational stability of the generators 7.

It should be noted that a priority of the early warning module is higher than that of the generator regulation module.

The operating principle is as follows: when the shaft-type power generation device based on a vertical temperature difference of a mountain body and solar heat collection is in use, the temperature difference between the wind outlet and the wind inlet of the shaft way 3 is utilized to drive the generators 7 to operate for power generation. The heat storage device 12 and the heat absorption device 4 are additionally disposed, such that a large amount of heat is accumulated at the wind inlet, thereby enabling the device to operate for power generation throughout the year. Considering that the airflow in the shaft way 3 will be relatively slow when the temperature difference between the top and foot of the mountain is less than a certain range, the airflow sequentially passes through the three generators 7 to further reduce the flow velocity. Therefore, when the temperature difference between the top and foot of the mountain is small, the airflow cannot exit from the wind outlet smoothly. In this case, the environmental monitoring component can be used to collect data on the surrounding environment of the device, and the wind direction detection module and the generator regulation module can be used to analyze the collected data in real time, such that the deflection states of the blades 702 on the three generators 7 can be controlled as needed based on the analyzed data. Before control, the wind direction of the current environment is detected and the wind direction influence level is set. The temperature difference trigger threshold WC is regulated based on the wind direction influence level. The temperature difference trigger threshold WC that triggers the regulating component to operate is relatively low when the natural wind entered superimposes and accelerates the airflow in the shaft way 3 and is relatively high when the natural wind entered does not accelerate the airflow in the shaft way 3.

When the actual temperature difference is less than the temperature difference trigger threshold WC, the wind velocity and the Reynolds number of the fluid in the shaft way 3 are further determined. When the fluid is the high-velocity turbulent flow state, the blades 702 of the generator 7 located at the middle position are controlled to deflect, such that they are in the non-obstructing state. In this case, the upper and lower generators 7 are used for power generation. Due to the high wind velocity, the airflow in the shaft way 3 can circulate. In addition, the blades 702 of the middle generator 7 do not obstruct the airflow, thereby increasing a distance between the adjacent operating generators 7 and avoiding the further intensification of turbulence in the adjacent operating generators 7 due to the high Reynolds number, while not affecting the continuity of the overall power generation operation of the device.

When the fluid is in the low-velocity state, the blades 702 of the two generators 7 located at the middle position and the position close to the wind outlet are controlled to deflect, such that they are in the non-obstructing state. In this case, the generator 7 that first comes into contact with the airflow is used for power generation. This approach, while maintaining overall sustainable power generation, reduces the resistance of the airflow passing through the shaft way 3 by reducing the overall power generation capacity of the device per unit time, thereby avoiding the difficulty of airflow circulation in the shaft way 3. When the fluid is in the high-velocity and low-Reynolds-number state, due to the high wind velocity, the effect of the Reynolds number needs not be considered, that is, all the three generators 7 operate normally. In this way, poor airflow circulation in the shaft way 3 can be avoided in a targeted manner by reducing airflow resistance as needed.

In addition, when the wind pressure fluctuation in shaft way 3 is excessive, all the three regulating components operate to cause the blades 702 of all the three generators 7 to be in a non-operating state, thus avoiding abnormal operating environments and preventing impact on the long-term operational stability of the generators 7.

While the examples of the present invention have been shown and described, it can be understood by those of ordinary skill in the art that various changes, modifications, substitutions, and variations can be made to these examples without departing from the principle and spirit of the present invention. The scope of the present invention is defined by the appended claims and their equivalents.

1. A shaft-type power generation device based on a vertical temperature difference of a mountain body and solar heat collection, comprising a shaft way (3) formed in the mountain body (2), wherein a wind inlet is formed in a bottom of the shaft way (3), a wind outlet is formed in a top of the shaft way (3), a heat storage device (12) is laid on a ground surface (1) at the wind inlet, a heat absorption device (4) is erected on the ground surface (1) at the wind inlet, a support formwork (5) is fixedly mounted on an inner wall of the shaft way (3), three generators (7) are respectively fixedly mounted in the shaft way (3) via three mounting frames (6) on the support formwork (5), and maintenance chambers (8) corresponding to the three generators (7) respectively are disposed in the mountain body (2);
each of the generators (7) comprises a central shaft (701), twenty-five blades (702), twenty-five rotating shafts (703), a current receiving assembly (706), and an induction frame (705), wherein ends of the twenty-five rotating shafts (703) are jointly rotatably connected to a power generation coil (704), the power generation coil (704) is rotatably connected to an inner wall of the induction frame (705), the central shaft (701) is rotatably connected to an inner wall of each of the generators (7), and a regulating component for synchronously controlling deflection states of the twenty-five blades (702), and a locking component are disposed in the central shaft (701); and
the shaft-type power generation device further comprises an environmental monitoring component, a wind direction detection module, a generator regulation module, and an early warning module, wherein the wind direction detection module is configured to detect a wind inlet angle θ and regulate a temperature difference trigger threshold WC accordingly, the generator regulation module is configured to evaluate operating states of the three generators (7) based on environmental data, the early warning module is configured to analyze a wind pressure fluctuation in the shaft way (3), and the regulating components are configured to automatically regulate the blades (702) based on the operating states of the generators (7) and the wind pressure fluctuation in the shaft way (3).

2. The shaft-type power generation device based on a vertical temperature difference of a mountain body and solar heat collection according to claim 1, wherein the environmental monitoring component comprises:
a first temperature sensor and a second temperature sensor disposed at the wind inlet and the wind outlet of the shaft way (3) respectively, wherein a vane is disposed on the ground surface (1) at the wind inlet, a flow velocity sensor and a viscometer are disposed at the wind inlet of the shaft way (3), and a wind pressure sensor is disposed at the wind inlet of the shaft way (3).

3. The shaft-type power generation device based on a vertical temperature difference of a mountain body and solar heat collection according to claim 2, wherein the regulating component comprises:
a gear ring (10), wherein shaft walls of the twenty-five rotating shafts (703) are all rotatably connected to an inner wall of the central shaft (701), the shaft walls of the twenty-five rotating shafts (703) are fixedly connected to inner walls of the twenty-five blades (702) respectively, the shaft walls of the twenty-five rotating shafts (703) are all fixedly connected to gears (11), teeth of the twenty-five gears (11) are all engaged with teeth of the gear ring (10), the inner wall of each of the generators (7) is fixedly connected to a regulating motor (9), and an output end of the regulating motor (9) is fixedly connected to a surface of the gear ring (10); and
the locking component.

4. The shaft-type power generation device based on a vertical temperature difference of a mountain body and solar heat collection according to claim 3, wherein a detection process for the wind direction detection module is as follows:
a radial coincident direction of the wind inlet of the shaft way (3) is defined as a 90° direction;
$$WD = \{ \begin{matrix}1 , & if 70 ° \leq θ \leq 110 ° \\ 2 , & if 45 ° < θ < 70 ° or 110 ° < θ < 135 ° \\ 3 , & if 0 ° \leq θ \leq 45 ° or 135 ° \leq θ \leq 180 °\end{matrix} ;$$
wherein, WD denotes a wind direction influence level;
θ denotes the wind inlet angle of the shaft way (3);
$$WC = α \times ( {W}_{1} - {W}_{2} ) ;$$
wherein, WC denotes the temperature difference trigger threshold;
W₁ is a temperature at the wind inlet at the foot of a mountain;
W₂ is a temperature at the wind outlet at the top of the mountain;
when WD=1, a high level is indicated, representing that an external wind direction is in a state of superimposing and accelerating an airflow in the shaft way (3), in which case α is taken as
$$\frac{1}{2} ;$$
when WD=2, a medium level is indicated, representing that the external wind direction is in a state of merely accelerating the airflow in the shaft way (3), in which case α is taken as
$$\frac{3}{5} ;$$
when WD=3, a low level is indicated, representing that the external wind direction is in a state of non-accelerating the airflow in the shaft way (3), in which case α is taken as 1; and
a wind direction of a current environment is detected, the wind direction influence level is set, the temperature difference trigger threshold WC is regulated based on the wind direction influence level, and the regulating component is not started when an actual temperature difference≥the temperature difference trigger threshold WC and is started when the actual temperature difference<the temperature difference trigger threshold WC.

5. The shaft-type power generation device based on a vertical temperature difference of a mountain body and solar heat collection according to claim 4, wherein the environmental data comprises a flow velocity v of a fluid and a fluid Reynolds number Rₑ, and during regulation by the generator regulation module, the flow velocity v of the fluid is obtained as follows:
$$v = \frac{{P}_{air}}{{ρ}_{air}} ;$$
wherein, v is the flow velocity of the fluid;
Pₐᵢᵣ is an air pressure;
ρₐᵢᵣ is an air density;
a wind velocity threshold for the flow velocity v of the fluid is set as V₁; when the flow velocity v of the fluid>the wind velocity threshold V₁, a high wind velocity state is indicated;
when the flow velocity v of the fluid≤the wind velocity threshold V₁, a low wind velocity state is indicated;
the fluid Reynolds number Rₑ is obtained as follows:
$${R}_{e} = \frac{ρ vd}{μ} ;$$
wherein, Rₑ is the fluid Reynolds number;
v is the flow velocity of the fluid;
ρ is a fluid density;
μ is a viscosity coefficient;
d is a shaft way length;
a Reynolds threshold for the fluid Reynolds number Rₑ is set as R₁;
when Rₑ>R₁, a high Reynolds number is indicated, representing that the airflow is in a turbulent state;
when Rₑ≤R₁, a low Reynolds number is indicated, representing that the airflow is in a laminar state;
$$A = \{ \begin{matrix}a , & V > {V}_{1} ⋂ {R}_{e} > {R}_{1} \\ b , & V < {V}_{1} ⋂ ( {R}_{e} > {R}_{1} ⋃ {R}_{e} \leq {R}_{1} ) \\ c , & V > {V}_{1} ⋂ {R}_{e} < {R}_{1}\end{matrix} ;$$
wherein, A=a, A=b, and A=c respectively denotes three fluid states in the shaft way (3);
when A=a, a first level is indicated, representing that the fluid is in a high-velocity turbulent flow state;
when A=b, a second level is indicated, representing that the fluid is in a low-velocity state;
when A=c, a third level is indicated, representing that the fluid is in a high-velocity laminar flow state; and
the generator (7) located at a middle position of the shaft way is shut down at the first level, the two generators (7) located at the middle position and a position close to the wind outlet are shut down at the second level, and none of the three generators (7) are shut down at the third level.

6. The shaft-type power generation device based on a vertical temperature difference of a mountain body and solar heat collection according to claim 5, wherein an early warning process for the early warning module is as follows:
$$p ( t ) = \frac{1}{2} \times ρ ( t ) \times {v ( t )}^{2} ;$$
wherein, p(t) is a wind pressure at a time point t;
ρ(t) is an air density at the time point t, which varies with the temperature and the air pressure;
v(t) is a wind velocity at the time point t;
$$Δ p = \vert p ( t ) - p ( t - 1 ) \vert ;$$
wherein, p(t) is the wind pressure at the time point t;
p(t−1) is a wind pressure at a time point t−1;
Δp is a wind pressure difference between the time point t and the time point t−1; and
a wind pressure threshold for the wind pressure difference Δp between the time point t and the time point t−1 is set as Δp_{threshold}, and if the wind pressure threshold Δp_{threshold}<the wind pressure difference Δp between the time point t and the time point t−1, excessive wind pressure fluctuation is determined, the twenty-five blades (702) on each of the generators (7) possibly encounter an uneven wind pressure affecting safe operation, and all the three regulating components operate to cause the blades (702) of the three generators (7) to be all in a non-operating state.

7. The shaft-type power generation device based on a vertical temperature difference of a mountain body and solar heat collection according to claim 3, wherein the locking component comprises:
an electromagnet (21), wherein the electromagnet (21) is embedded in the inner wall of the induction frame (705), and an inner wall of the power generation coil (704) is embedded with an iron ring (22).

8. The shaft-type power generation device based on a vertical temperature difference of a mountain body and solar heat collection according to claim 7, wherein the blades (702) are made of a waterproof and corrosion-resistant material, the heat storage device (12) stores heat using cobblestones, and the heat absorption device (4) absorbs heat by erecting a plastic film.
